(19) United States
(12) Patent Application Publication
(10) Pub. No.: US 2014/0349025 A1
(43) Pub. Date: Nov. 27, 2014

(54) CONDUCTIVE COMPOSITIONS AND METHODS RELATING THERETO

(71) Applicant: E I DU PONT DE NEMOURS AND COMPANY, Wilmington, DE (US)

(72) Inventors: DAVE HUI, BRISTOL (GB); GARETH JAMES GRIFFITHS, BRISTOL (GB)

(73) Assignee: E I DU PONT DE NEMOURS AND COMPANY, Wilmington, DE (US)

(21) Appl. No.: 14/268,202

(22) Filed: May 2, 2014

Related U.S. Application Data
(60) Provisional application No. 61/826,682, filed on May 23, 2013.

(51) Int. Cl. H01B 1/22; H01B 13/00

(52) U.S. Cl. CPC H01B 1/22; H01B 13/003
USPC 427/492; 252/514

(57) ABSTRACT

A conductive composition is disclosed, In one embodiment, the composition comprises 40 to 90 wt % of silver particles having an average particle size in the range of 10 to 450 nm and having an aspect ratio of 3 to 1:1, 2 to 20 wt % of an alkyl carbonyl macromolecule resin having a weight-average molar mass of 4,000 to 200,000 and 10 to 58 wt % of a diluent for the resin. In one embodiment, the resin is ethyl cellulose.

### FIELD OF THE INVENTION

The field of the invention is formable, such as by curing, (e.g., printable) conductive compositions useful in electronic circuitry type applications, or the like.

### BACKGROUND OF THE INVENTION

Broadly speaking, silver pastes for screen printing metal circuitry are known. A need exists however for improved silver pastes that provide higher performance with a lower total cost of ownership. CN 102277109 is directed to conductive silver pastes that can be cured by photonic (i.e., light) energy and that contain flakes of silver powder, organic resin (polyacrylic acid resin or epoxy resin), solvent and an imidazole derivative as a curing accelerator.

### SUMMARY OF THE INVENTION

The invention is directed to formable conductive compositions, such as a curable metal paste, which includes (in it's uncured or otherwise precursor state):
a. a weight percent of silver particles in a range between and optionally including any two of the following weight percentages: 40, 42,45, 48, 50, 52, 55, 58, 60, 65, 70, 75, 78, 80, 82, 85, 87, and 90 wt % (weight %) having an average primary particle size in a range between and optionally including any of the following sizes (in nanometers): 10, 12, 15, 17, 20, 22, 25, 27, 30, 35, 40, 45, 50, 55, 60, 65, 70, 75, 80, 85, 90, 95, 100, 125, 150, 175, 200, 250, 300, 325, 350, 375, 370, 385, 390, 395, 400, 410, 420, 430, 440, 445 and 450 nm, the silver particles having an aspect ratio of A:B, where A is a range between and optionally including any two of the following: 3, 2.5, 2, 1.5 and 1, and B is 1,
b. a weight percent of a resin in a range between and optionally including any two of the following weight percentages: 2, 3, 4, 5, 7, 10, 12, 15, 16, 17, 18, 19, 20 wt %, wherein the resin comprises an alkyl-carbonyl macromolecule, such as an alkyl functionalized saccharide, for example, an alkyl cellulose, such as ethyl cellulose, wherein the resin has a weight-average molecular weight (as defined by ASTM D6579) in a range between and optionally including any two of the following weight average molecular weights: 4,000, 5000, 6000, 7000, 8000, 9000, 10,000, 12,000, 14,000, 15,000, 17,000, 20,000, 25,000, 50,000, 75,000, 100,000, 125,00, and 200,000, and furthermore, the resin also contains about 45 to 53wt % alkoxyl (e.g. ethoxyl) moieties and about 10 to 58 wt % of a diluent.

In one embodiment, the immediately above described precursor compositions of the present disclosure is deposited on a releasable substrate and then wholly or partially cured or otherwise wholly or partially solidified into a substantially self supporting film that can be removed from the releasable substrate to provide a substantially self-supporting conductive film having on at least one side, an Rₐ surface roughness of less than 5, 10, 15, 20, 25, 30, 35, 40, 50, 75, 100, 150, 200, 250, 300, 350, 400, 450, or 500 nanometers (nm), depending upon the embodiment desired or selected. The resulting film has been found to have sufficient structural integrity to be moved and applied into a circuitry system, such as, a photovoltaic system, such as by a reel to reel manufacturing operation or the like.

### DETAILED DESCRIPTION OF THE PREFERRED EMBODIMENT(S)

In the description and the claims the term “average particle size” is used and shall mean the average primary particle size (mean particle diameter, d50) determined by means of laser light scattering. Laser light scattering measurements can be carried out making use of a particle size analyzer, for example, a Microtrac S3500 machine. Alternatively or in addition, the d50 mean particle diameter can be determined by electron microscopy.

In the description and the claims, the term “aspect ratio” is used with regard to the shape of the silver particles included in the conductive composition of the invention. It means the ratio of the largest dimension to the smallest dimension of a silver particle and it is determined by electron microscopy and evaluating the electron microscopical images by measuring the dimensions of a statistically meaningful number of individual silver particles.

In the description and the claims, the term “weight-average molar mass” or “weight average molecular weight” is used. It shall mean the weight-average molar mass as determined by gel permeation chromatography (GPC; divinylbenzene-cross-linked polystyrene as the immobile phase, tetrahydrofuran as the liquid phase, polystyrene standards).

With the conductive compositions of the present disclosure, the applicant has found an improved conductive composition in terms of low resistivity and good physical flexibility of a conductive metallization applied therefrom on a substrate and cured by photonic sintering. Said low resistivity can be in the range of, for example, only 6 to 25 μΩ·cm.

The conductive composition of the invention includes 40 to 90 wt %, or, in an embodiment, 65 to 80 wt % of silver particles, based on total conductive composition. The silver particles may be uncoated or at least partially coated with a surfactant. The surfactant may be selected from, but is not limited to, stearic acid, palmitic acid, lauric acid, oleic acid, capric acid, myristic acid and linolic acid and salts thereof, for example, ammonium, sodium or potassium salts.

The silver particles can have an average particle size in a range of 10 to 450 nm.

The silver particles can exhibit an aspect ratio in the range of 3 to 1:1, or, in an embodiment, 2 to 1:1. Said aspect ratio shall express that the silver particles have a true spherical or essentially spherical shape as opposed to irregular silver particles like, for example, acicular silver particles (silver needles) or silver flakes (silver platelets). The individual silver particles when looked at under an electron microscope have a ball like or near-to-ball like shape, i.e., they may be perfectly round or almost round, elliptical or they may have an ovoid shape. The silver particles' surface may be uniform and it may exhibit a smooth radius of curvature.

Silver particles having an average primary particle size in the range of 10 to 450 nm and having an aspect ratio in the range of 3 to 1:1 are commercially available. Examples of commercially available silver particles that would be appropriate in the practice of the present invention, include (but are not limited to) Silver Powder 7000-24 and 7000-35 from Ferro Corporation of Swedesburo, N.J., USA.

In one embodiment, the conductive composition of the invention includes 2 to 20 wt % or, in another embodiment, 2 to 10 wt % of an ethyl cellulose resin as a binder. The 2 to 20 wt % mean ethyl cellulose solids, based on total conductive composition.

The ethyl cellulose resin has a weight-average molar mass of 4,000 to 200,000 or, in an embodiment, of 4,000 to 22,000. If the weight-average molar mass is below 4,000, the viscosity of the conductive composition is too low and its application and spreading behavior might suffer; if it exceeds 200,000, the electrical conductivity of the applied and cured conductive composition might suffer and the viscosity of the conductive composition may be too high.

Ethyl cellulose resins having a weight-average molar mass in the range of 4,000 to 200,000 are commercially available. Examples of such commercially available ethyl cellulose resins are the products Aqualon® EC from Ashland.

The conductive composition of the invention includes 10 to 58 wt %, or, in an embodiment, 10 to 40 wt %, of a diluent for the ethyl cellulose resin. The diluent may be water, a mixture of water and one or more organic solvents, a single organic solvent or a mixture of two or more organic solvents which dissolves/dissolve the ethyl cellulose resin and which can evaporate from a metallization applied from the conductive composition of the invention before and/or while being cured by photonic sintering. Examples of suitable organic solvents include n-pentane, toluene, methyl ethyl ketone, methylene chloride, acetone, diols like ethylene glycol, propylene glycol, diethylene glycol, triethylene glycol and hexylene glycol, ethanol, methanol, propanol, cyclohexanol, chlorinated hydrocarbons, methyl acetate, ethyl acetate, propyl acetate, glycol diacetate, ethyl formate, ethyl ether, carbitol, aliphatic hydrocarbons, ketones, or any combination thereof.

The conductive composition of the invention may or may not include at least one additive. Accordingly, the proportion of the at least one additive may be in the range of, for example, 0 to 2 wt %, based on total conductive composition. Examples of possible additives include defoamers, levelling agents and rheology control agents.

In an embodiment, the conductive composition of the invention consists of 40 to 90 wt % of silver particles having an average particle size in the range of 10 to 450 nm and having an aspect ratio of 3 to 1:1, 2 to 20 wt % of ethyl cellulose resin having a weight-average molar mass of 4,000 to 200,000, 10 to 58 wt % of a diluent for the ethyl cellulose resin, and 0 to 2 wt % of at least one additive, wherein the sum of the wt % totals 100 wt %.

The conductive compositions of the present disclosure are generally initially a viscous composition, which may be prepared by mechanically mixing the silver particles with the ethyl cellulose resin, the diluent and the optional one or more additives. In an embodiment, it may be prepared by mechanically mixing the silver particles with a solution of the ethyl cellulose resin in the diluent. In an embodiment, the manufacturing method includes power mixing, a dispersion technique that is substantially equivalent to traditional roll milling, may be used; roll milling or other mixing technique can also be used. The possible one or more additives may be added at various stages of the mixing process, for example, before and/or during the mixing process.

The conductive composition of the present disclosure may be used in the production of conductive metallizations on substrates. In an embodiment, the conductive metallization may serve as a conductive track. In another embodiment it may serve as a collector electrode.

Therefore the present disclosure relates also to such production process and to substrates provided with conductive metallizations made by said production process. Said production process includes the steps:
(1) providing a substrate,
(2) applying the conductive composition of the invention on the substrate, and
(3) subjecting the conductive composition applied in step (2) to photonic sintering to form the conductive metallization.

In step (1) of the process of the invention a substrate is provided. The substrate may be comprised of one or more than one material. The term “material” used herein in this context refers primarily to the bulk material or the bulk materials the substrate is comprised of. However, if the substrate is comprised of more than one material, the term “material” shall not be misunderstood to exclude materials present as a layer. Rather, substrates comprised of more than one material include substrates comprised of more than one bulk material without any thin layers as well as substrates comprised of one or more than one bulk material and provided with one or more than one thin layer. Examples of said layers include dielectric (electrically insulating) layers and active layers.

Examples of dielectric layers include layers of inorganic dielectric materials like silicon dioxide, zirconia-based materials, alumina, silicon nitride, aluminum nitride and hafnium oxide; and organic dielectric materials, e.g. fluorinated polymers like PTFE, polyesters and polyimides.

The term “active layer” is used in the description and the claims. It shall mean a layer selected from the group including photoactive layers, light-emissive layers, semiconductive layers and non-metallic conductive layers. In an embodiment, it shall mean layers selected from the group consisting of photoactive layers, light-emissive layers, semiconductive layers and non-metallic conductive layers.

For the purpose of the present disclosure, the term “photoactive” used herein shall refer to the property of converting radiant energy (e.g., light) into electric energy.

Examples of photoactive layers include layers based on or including materials like copper indium gallium diselenide, cadmium telluride, cadmium sulphide, copper zinc tin sulphide, amorphous silicon, organic photoactive compounds or dye-sensitized photoactive compositions.

Examples of light-emissive layers include layers based on or including materials like poly(p-phenylene vinylene), tris(8-hydroxyquinolinato)aluminum or polyfluorene (derivatives).

Examples of semiconductive layers include layers based on or including materials like copper indium gallium diselenide, cadmium telluride, cadmium sulphide, copper zinc tin sulphide, amorphous silicon or organic semiconductive compounds.

Examples of non-metallic conductive layers include layers based on or including organic conductive materials like polyaniline, PEDOT:PSS (poly-3,4-ethylenedioxythiophene polystyrenesulfonate), polythiophene or polydiacetylene; or based on or including transparent conductive materials like indium tin oxide (ITO), aluminum-doped zinc oxide, fluorine-doped tin oxide, graphene or carbon nanotubes.

In an embodiment, the substrate is a temperature-sensitive substrate. This means that the material or one or more of the materials the substrate is comprised of are temperature-sensitive. For the avoidance of doubt, this includes such cases, where the substrate includes at least one of the aforementioned layers wherein the layer or one, more or all layers are temperature-sensitive.

The term “temperature-sensitive” as opposed to “temperature-resistant” is used herein with reference to a substrate, a substrate material (=the or one of the bulk materials a substrate is comprised of) or a layer of a substrate and its behavior when exposed to heat. Hence, “temperature-sensitive” is used with reference to a substrate, a substrate material or a layer of a substrate which does not withstand a high object peak temperature of >130° C. or, in other words, which undergoes an unwanted chemical and/or physical alteration at a high object peak temperature of >130° C. Examples of such unwanted alteration phenomena include degradation, decomposition, chemical conversion, oxidation, phase transition, melting, change of structure, deformation and combinations thereof. Object peak temperatures of >130° C. occur for example during a conventional drying or firing process as is typically used in the manufacture of metallizations applied from metal pastes containing conventional polymeric resin binders or glass binders.

Accordingly, the term “temperature-resistant” is used herein with reference to a substrate, a substrate material or a layer of a substrate which withstands an object peak temperature of >130° C.

A first group of examples of substrate materials includes organic polymers. Organic polymers may be temperature-sensitive. Examples of suitable organic polymer materials include PET (polyethylene terephthalate), PEN (polyethylene napthalate), PP (polypropylene), PC (polycarbonate) and polyimide.

A second group of examples of substrate materials includes materials other than an organic polymer, in particular, inorganic non-metallic materials and metals. Inorganic non-metallic materials and metals are typically temperature-resistant. Examples of inorganic non-metallic materials include inorganic semiconductor materials like monocrystalline silicon, polycrystalline silicon, silicon carbide; and inorganic dielectric materials like glass, quartz, zirconia-based materials, alumina, silicon nitride and aluminum nitride. Examples of metals include aluminum, copper and steel.

The substrates may take various forms, examples of which include the form of a film, the form of a foil, the form of a sheet, the form of a panel and the form of a wafer.

In step (2) of the process of the invention the conductive composition is applied on the substrate. In case the substrate is provided with at least one of the aforementioned layers, the conductive composition may be applied on such layer. The conductive composition may be applied to a dry film thickness of, for example, 0.1 to 100 μm. The method of conductive composition application may be printing, for example, flexographic printing, gravure printing, ink-jet printing, offset printing, screen printing, nozzle/extrusion printing, aerosol jet printing, or it may be pen-writing. The variety of application methods enables the conductive composition to be applied to cover the entire surface or only one or more portions of the substrate. It is possible for example to apply the conductive composition in a pattern, wherein the pattern may include fine structures like dots or thin lines with a dry line width as low as, for example, 10 or 20 μm.

After its application on the substrate the conductive composition may be dried in an extra process step prior to performing step (3) or it may directly (i.e. without deliberate delay and without undergoing an especially designed drying step) be subject to the photonic sintering step (3). Such extra drying step will typically mean mild drying conditions at a low object peak temperature in the range of 50 to ≦130° C.

The term “object peak temperature” used herein in the context of said optional drying means the substrate peak temperature reached during drying of a conductive metallization applied from the conductive composition of the invention onto the substrate.

The primary target of said optional drying is the removal of solvent; however, it may also support the densification of the metallization matrix. The optional drying may be performed, for example, for a period of 1 to 60 minutes at an object peak temperature in the range of 50 to ≦130° C., or, in an embodiment, 80 to ≦130° C. The skilled person will select the object peak temperature considering the thermal stability of the ethyl cellulose resin and of the substrate provided in step (1) and the type of diluent included in the conductive composition of the invention.

The optional drying can be carried out making use of, for example, a belt, rotary or stationary dryer, or a box oven. The heat may be applied by convection and/or making use of IR (infrared) radiation. The drying may be supported by air blowing.

Alternatively, the optional drying may be performed using a method which induces a higher local temperature in the metallization than in the substrate as a whole, i.e. in such case the object peak temperature of the substrate may be as low as room temperature during drying. Examples of such drying methods include photonic heating (heating via absorption of high-intensity light), microwave heating and inductive heating.

In step (3) of the process of the invention the conductive metal composition applied in step (2) and optionally dried in the aforementioned extra drying step is subjected to photonic sintering to form the conductive metallization.

Photonic sintering which may also be referred to as photonic curing uses light, or, to be more precise, high-intensity light to provide high-temperature sintering. The light has a wavelength in the range of, for example, 240 to 1000 nm. Typically, flash lamps are used to provide the source of light and are operated with a short on time of high power and a duty cycle ranging from a few hertz to tens of hertz. Each individual flashlight pulse may have a duration in the range of, for example, 100 to 2000 microseconds and an intensity in the range of, for example, 30 to 2000 Joules. The flashlight pulse duration may be adjustable in increments of, for example, 5 microseconds. The dose of each individual flashlight pulse may be in the range of, for example, 4 to 15 Joule/cm².

The entire photonic sintering step (3) is brief and it includes only a small number of flashlight pulses, for example, up to 5 flashlight pulses, or, in an embodiment, 1 or 2 flashlight pulses. It has been found that the conductive composition of the invention, unlike known prior art conductive compositions, enables the photonic sintering step (3) to be performed in an unusually short period of time of, for example, ≦1 second, e.g. 0.1 to 1 seconds, or, in an embodiment, ≦0.15 seconds, e.g. 0.1 to 0.15 seconds; i.e. the entire photonic sintering step (3) commencing with the first flashlight pulse and ending with the last flashlight pulse can be as short as, for example, ≦1 second, e.g. 0.1 to 1 seconds, or, in an embodiment, ≦0.15 seconds, e.g. 0.1 to 0.15 seconds.

The conductive films created in accordance with the present disclosure can be used as donor substrates for photovoltaic applications, and as such, can be used in association with acceptor substrates.

The metallized substrate obtained after conclusion of step (3) of the process of the invention may represent an electronic device, for example, a printed electronic device. However, it is also possible that it forms only a part of or an intermediate in the production of an electronic device. Examples of said electronic devices include RFID (radio frequency identification) devices; PV (photovoltaic) or OPV (organic photovoltaic) devices, in particular solar cells; light-emissive devices, for example, displays, LEDs (light emitting diodes), OLEDs (organic light emitting diodes); smart packaging devices; and touchscreen devices. In case the metallized substrate forms only said part or intermediate it is further processed. One example of said further processing may be encapsulation of the metallized substrate to protect it from environmental impact. Another example of said further processing may be providing the metallization with one or more of the aforementioned dielectric or active layers, wherein in case of an active layer direct or indirect electrical contact is made between metallization and active layer. A still further example of said further processing is electroplating or light-induced electroplating of the metallization which then serves as a seed metallization.

1. A conductive composition comprising:
a. 40 to 90 wt % of silver particles having an average particle size in the range of 10 to 450 nm and having an aspect ratio of 3 to 1:1,
b. 2 to 20 wt % of an alkyl carbonyl resin having a weight-average molar mass of 4,000 to 200,000, and
c. 10 to 58 wt % of a diluent.

2. The conductive composition of claim 1, wherein the silver particles are 40 to 90 wt % of the composition and the composition is solidified into a self supporting, flexible film having an Ra surface roughness of less than 50 nanometers.

3. The conductive composition of claim 2, wherein the silver particles have an average particle size in a range of 15 to 130 nm and the Ra surface roughness is less than 50 nanometers.

4. The conductive composition of claim 3, wherein the alky carbonyl resin is an ethyl cellulose resin in an amount of 2 to 15 wt % of the conductive composition.

5. The conductive composition of claim 4, wherein the ethyl cellulose resin has a weight-average molar mass of 4,000 to 50,000.

6. The conductive composition of claim 1, wherein the diluent is 10 to 40 wt % of the conductive composition.

7. The conductive composition of claim 1, wherein the diluent is selected from the group consisting of water, a mixture of water and one or more organic solvents, a single organic solvent and a mixture of two or more organic solvents.

8. The conductive composition of claim 4 consisting essentially of:
a. 40 to 90 wt % of silver particles having an average particle size in the range of 10 to 450 nm and having an aspect ratio of 3 to 1:1,
b. 2 to 20 wt % of an ethyl cellulose resin having a weight-average molar mass of 4,000 to 200,000,
c. 10 to 58 wt % of a diluent for the ethyl cellulose resin, and
d. 0 to 2 wt % of at least one additive, wherein the sum of the wt % totals 100 wt %.

10. A process for the production of a conductive metallization on a substrate comprising the steps of:
A. providing a substrate,
B. applying a conductive composition on the substrate, the conductive composition comprising:
a. 40 to 90 wt % of silver particles having an average particle size in the range of 10 to 450 nm and having an aspect ratio of 3 to 1:1,
b. 2 to 20 wt % of an alkyl carbonyl resin having a weight-average molar mass of 4,000 to 200,000, and
c. 10 to 58 wt % of a diluent, and
C. subjecting the conductive composition applied in step (B) to a photonic sintering to form a conductive metallization on the substrate.

11. The process of claim 10, wherein the substrate comprises one or more than one material.

12. The process of claim 10, wherein the substrate is a temperature-sensitive substrate.

13. The process of claim 10, wherein the conductive composition is applied by printing or pen-writing.

14. The process of claim 10, wherein the applied conductive composition is dried prior to performing step (C).

15. The process of claim 10, wherein step (C) is performed within less than or equal to 1 second.
